(19) United States
(12) Patent Application Publication
(10) Pub. No.: US 2015/0062424 A1
(43) Pub. Date: Mar. 5, 2015

(54) CAMERA MODULE AND METHOD FOR ASSEMBLING SAME

(71) Applicant: HON HAI PRECISION INDUSTRY CO., LTD., New Taipei (TW)

(72) Inventor: SHIN-WEN CHEN, New Taipei (TW)

(21) Appl. No.: 14/477,873

(22) Filed: Sep. 5, 2014

(30) Foreign Application Priority Data
Sep. 5, 2013 (TW) 102131908

(51) Int. Cl. H04N 5/225; H04N 5/374; H04N 5/372

(52) U.S. Cl. CPC H04N 5/2257; H04N 5/372; H04N 5/374; H04N 5/2253; H04N 2209/042
USPC 348/374; 156/297

(57) ABSTRACT

A camera module includes a substrate, an image sensor electrically connected to a surface of the substrate, a lens holder connected to the substrate and covering the image sensor, a lens holder received into the lens holder, a connecting board, and an ACF positioned between the substrate and the connecting board. The image sensor includes a sensing surface and a number of side surfaces connecting to the sensing surface. The substrate is electrically and mechanically connected with each other by the ACF. An adhesive is distributed on each corner of the image sensor, and the adhesive connects the side surfaces of the image sensor to the substrate.

### FIELD

The present disclosure relates to a camera module and a method for assembling the camera module.

### BACKGROUND

In recent years, anisotropic conductive films (ACFs) are used in assembling of camera modules. The camera module generally includes a lens module, a lens holder, an image sensor, a substrate, and a connecting board. In assembly, the lens modules a received in the lens holder, the image sensor is electrically connected to the substrate, a bottom end of the lens holder is attached on the substrate, and the substrate is electrically and mechanically connected to the connecting board by an ACF. In an assembling process, a pressing force should be applied on the camera module to process the substrate on the connecting board.

### BRIEF DESCRIPTION OF THE DRAWING

The components of the drawing are not necessarily drawn to scale, the emphasis instead being placed upon clearly illustrating the principles of the embodiments of the present disclosure.

FIG. 1 is an exploded view of an exemplary embodiment of a camera module.

FIG. 2 is similar to FIG. 1, but showing the camera module from another angle.

FIG. 3 is an assembled view of the camera module of FIG. 1.

FIG. 4 is a flowchart of an exemplary embodiment of a method for assembling the camera module.

FIG. 5 is an isometric view of a substrate with a mounting adhesive distributed thereon.

FIG. 6 is an isometric view of the substrate of FIG. 5 with an image sensor mounted thereon.

FIG. 7 is an isometric view of a lens holder and a lens module, the lens module being received into the lens holder.

FIG. 8 is an isometric view of the substrate and the image sensor of FIG. 6 with a first adhesive distributed thereon.

FIG. 9 is an isometric view of an assembly of the lens holder and the lens module of FIG. 7, and the substrate of FIG. 8.

FIG. 10 is an isometric view of a connecting board with an ACF positioned thereon.

FIG. 11 is an isometric view of an assembly of the assembly of FIG. 9 and the connecting board of FIG. 10.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

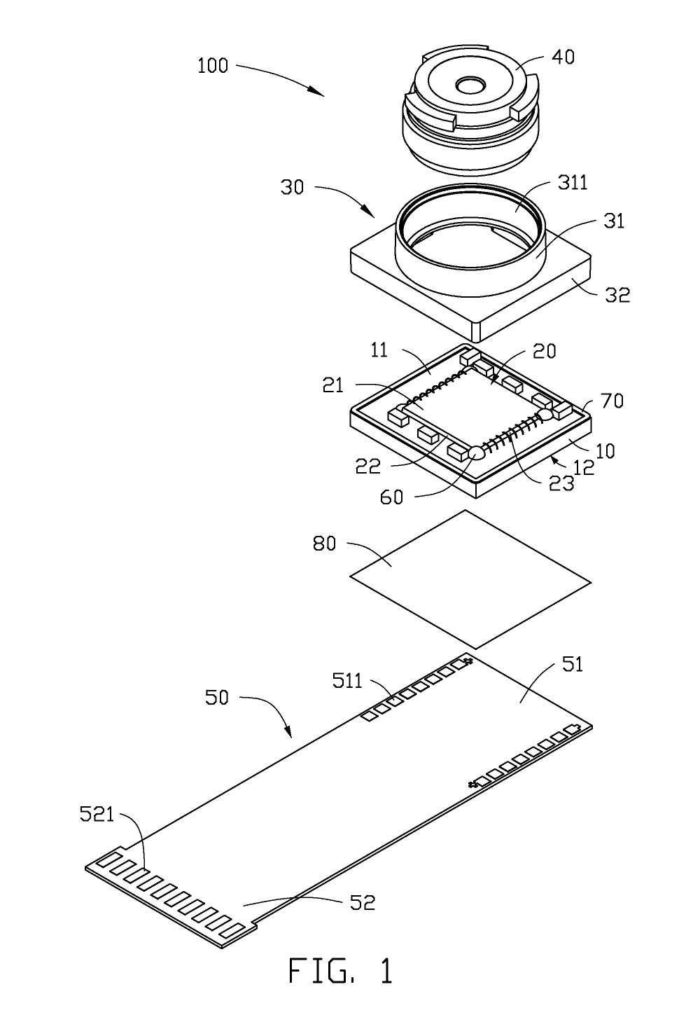

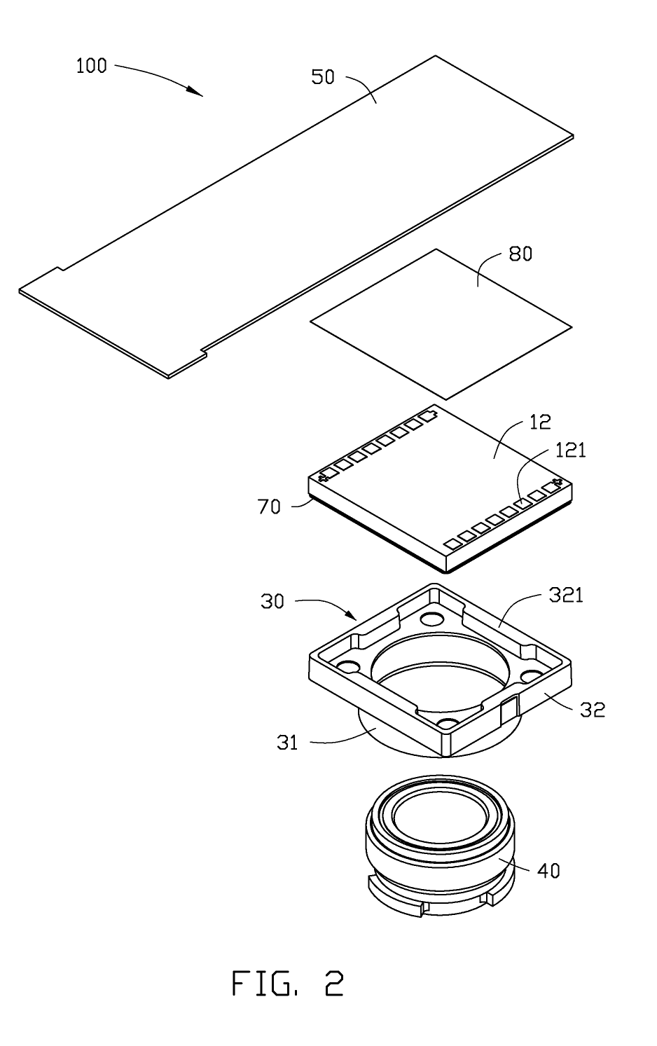

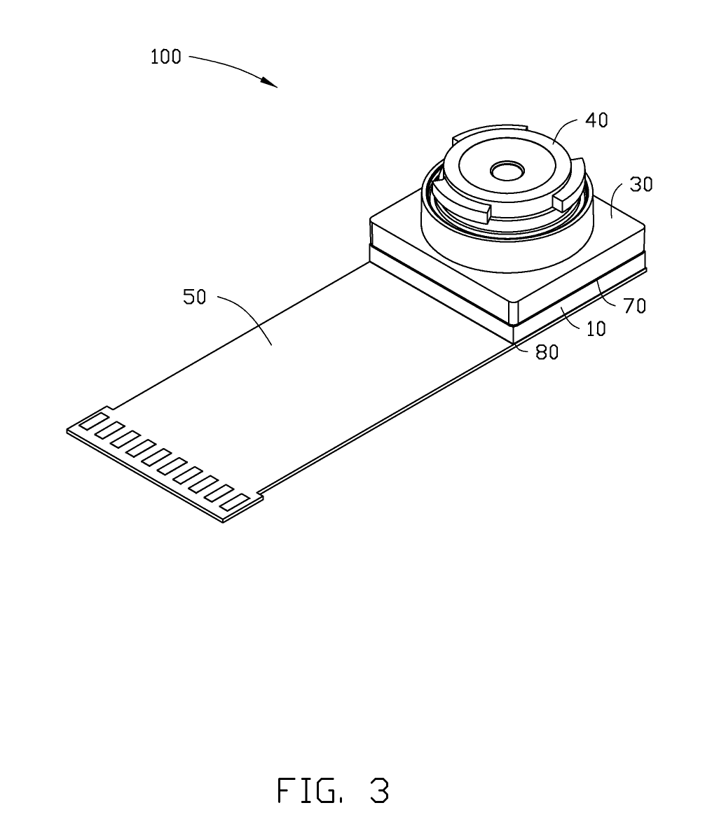

FIGS. 1-3 illustrate an exemplary embodiment of a camera module 100. The camera module 100 includes a substrate 10, an image sensor 20, a lens holder 30, a lens module 40, and a connecting board 50.

The substrate 10 includes a supporting surface 11 and a connecting surface 12 apposite to the supporting surface 11. The supporting surface 11 supports the image sensor 20 thereon. The substrate 11 may have a circuit (not shown) for transmitting electrical power and electrical signals therethrough. The substrate 10 includes a number of first connecting pads 121 connecting to the circuit. In this embodiment, the substrate 10 is a rigid printed circuit board (PCB).

The image sensor 20 is substantially rectangular-shaped. Te image sensor 20 is electrically connected to the supporting surface 11 of the substrate 10. The image sensor 20 includes a sensing surface 21, two first side surfaces 22, and two second side surfaces 23. The first side surfaces 22 and the second side surfaces 23 are perpendicularly connected to the sensing surface 21. The first side surfaces 22 are substantially parallel to each other, the second side surfaces 23 are substantially parallel to each other, and the first side surfaces 22 are substantially perpendicular to the second side surface 23. In this embodiment, the image sensor 20 can be a charge-coupled device (CCD) or a complementary metal oxide semiconductor (CMOS) sensor.

The lens holder 30 defines a chamber for receiving the lens module 40 and the image sensor 20. The lens holder 30 includes a receiving end 31 and an assembling end 31 connected to the receiving end 31. The lens holder 30 defines a receiving hole 311 in the receiving end 31. In this embodiment, the receiving hole 311 is a substantially circular hole. A shape of the assembling end 31 corresponds to that of the substrate 10. The assembling end 32 includes connecting surface 321 facing away from the receiving end 31.

The lens module 40 captures images of objects and projects the images on the image sensor 20.

The connecting board 50 is configured for connecting the substrate 10 to an outer circuit. The connecting board 50 includes a connecting portion 51 and an extending portion 52 connected to the connecting portion 51. The connecting portion 51 includes a number of second connecting pads 511 corresponding to the first connecting pads 121 formed on the substrate 10. The extending portion 52 includes a number of third connecting pads 521 for connecting to the outer circuit. In this embodiment, the connecting board 50 is a flexible PCB.

In assembly, the image sensor 20 is fixedly connected to the supporting surface 11 of the substrate 10, in detail, the image sensor 20 and the substrate 10 are connected to each other by a thermosetting adhesive (not shown). After the image sensor 20 is connected to the substrate, a first adhesive 60 is distributed on each corner of the image sensor 20. Each first adhesive 60 is distributed on a first surface 22, a second surface 23, and the supporting surface 11. The lens module 40 is received in the receiving hole 311, and the assembling end 32 is connected to the substrate 10. The lens holder 40 is connected to the substrate 10 by a second adhesive 70. In a process for assembling the lens holder on the substrate 10, the second adhesive 70 is pre-distributed on the supporting surface 11 surrounding the image sensor. Alternatively, the second adhesive 70 can also be pre-distributed on the connecting surface 321 of the lens holder 30. After the lens holder 40 is connected to the substrate 10, the substrate 10 and the connecting board 50 are electrically and mechanically connected to each other by an ACF 80. In detail, a force is applied for press the substrate 10 and the connecting board together each other, thus the first connecting pads 121 are electrically connected to the second connecting pads 511 by the ACF 80, respectively.

In this embodiment, the first adhesive 60 and the second adhesive 70 are thermosetting adhesive.

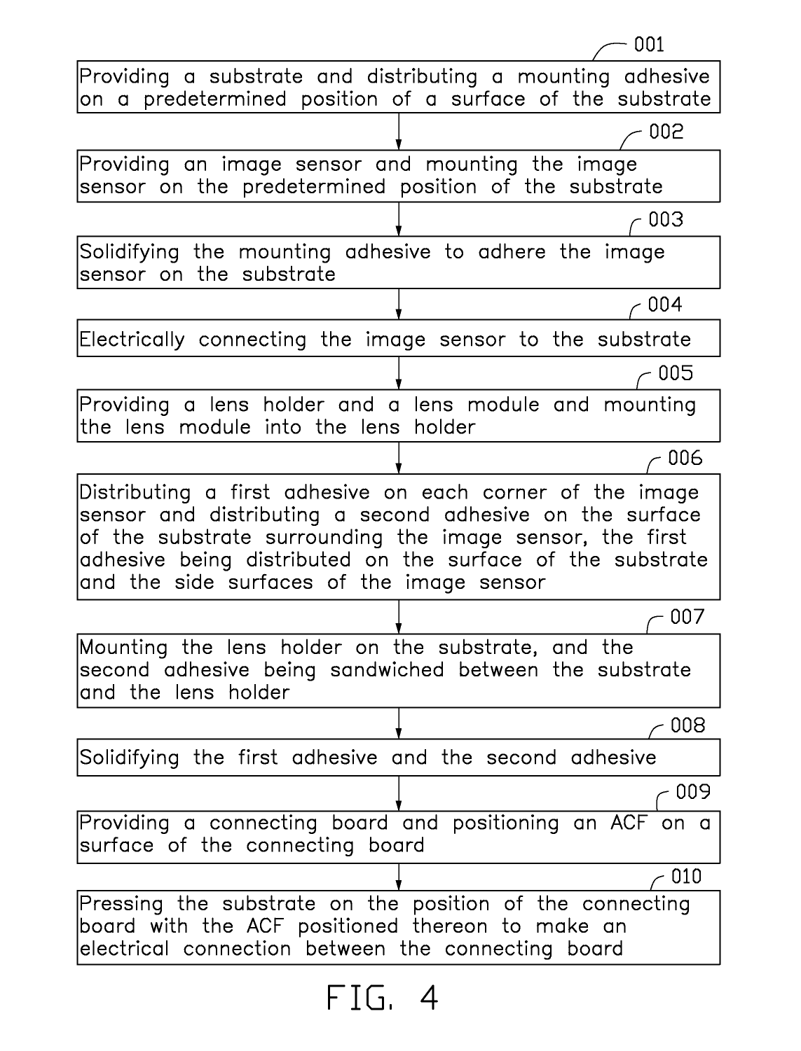

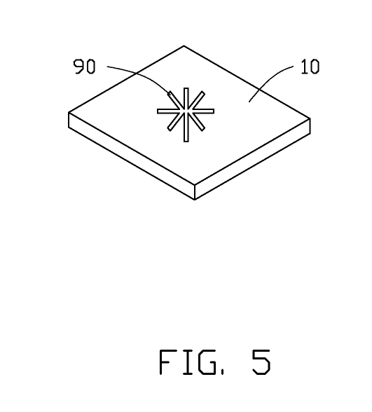

Referring to FIG. 4, a flowchart of a method for assembling a camera module is presented in accordance with an example embodiment. The example method is provided by way of example, as there are a variety of ways to carry out the method. The method described below can be carried out using the configurations illustrated in FIGS. 5-11, for example, and various elements of these figures are referenced in explaining example method. Each block shown in FIG. 4 represents one or more processes, methods or subroutines, carried out in the example method. Furthermore, the illustrated order of blocks is illustrative only and the order of the blocks can change according to the present disclosure. Additional blocks can be added or fewer blocks may be utilized, without departing from this disclosure. The example method can begin at block S1.

At block 001, referring also to FIG. 5, a substrate 10 is provided, and a mounting adhesive 90 is distributed on a predetermined position of a surface of the substrate 10. The predetermined position is a position to mount an image sensor. In this embodiment, the mounting adhesive 90 is thermosetting adhesive.

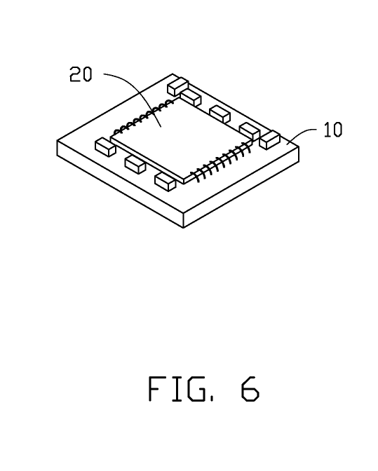

At block 002, referring also to FIG. 6, an image sensor 20 is provided, and the image sensor 20 is mounted on the predetermined position of the substrate 10.

At block 003, the mounting adhesive 90 is solidified to adhere the image sensor 20 on the substrate 10.

At block 004, the image sensor 20 is electrically connected to the substrate 10. In this embodiment, the image sensor 20 is electrically connected to the substrate 10 by a wire bonding process.

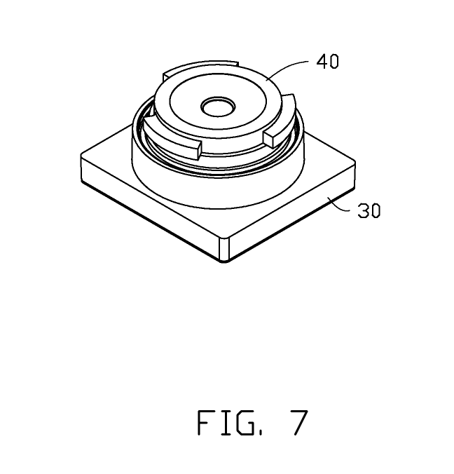

At block 005, referring also to FIG. 7, a lens holder 30 and a lens module 40 are provided. The lens module 40 is mounted into the lens holder 30.

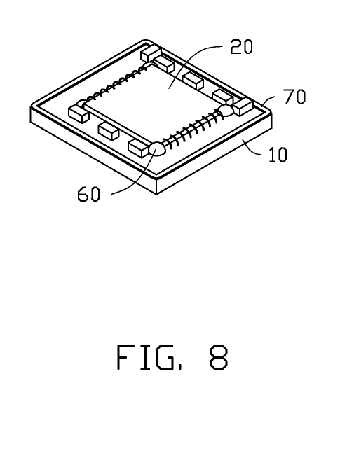

At block 006, referring also to FIG. 8, a first adhesive 60 is distributed on each corner of the image sensor 20, and a second adhesive 70 is distributed on the surface of the substrate 10 surrounding the image sensor 20. The first adhesive 60 is distributed on the surface of the substrate 10 and the side surfaces of the image sensor 20. In this embodiment, the first adhesive 60 and the second adhesive 70 are thermosetting adhesive.

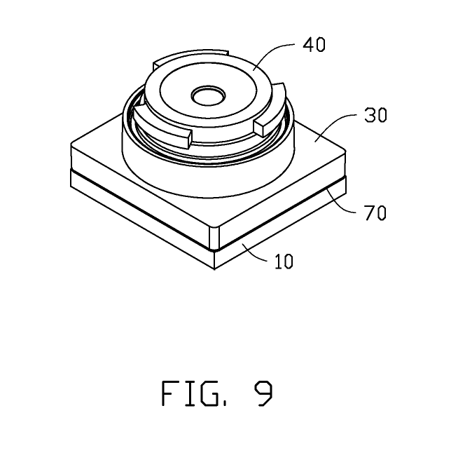

At block 007, referring also to FIG. 9, the lens holder 30 is mounted on the substrate 10, and the second adhesive 70 is sandwiched between the substrate 10 and the lens holder 30.

At block 008, the first adhesive 60 and the second adhesive 70 are solidified to fixedly connect the lens holder 30 and substrate 10 to each other and enhance a connection strength between the image sensor 20 and the substrate 10.

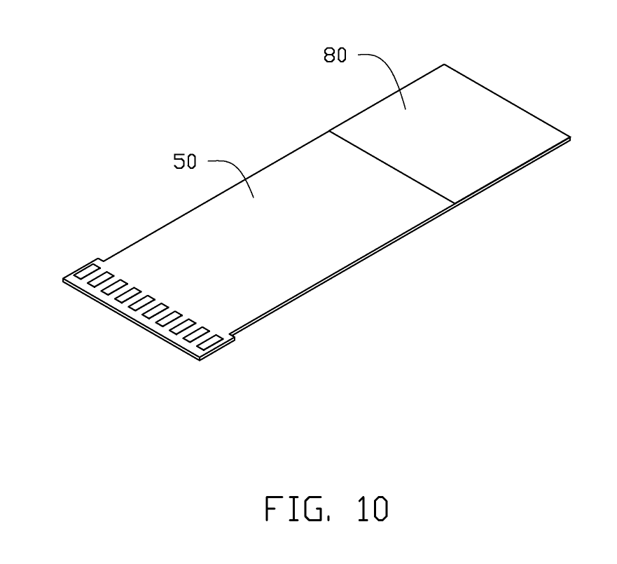

At block 009, referring also to FIG. 10, a connecting board 50 is provided, and an ACF 10 is positioned on a surface of the connecting board 50.

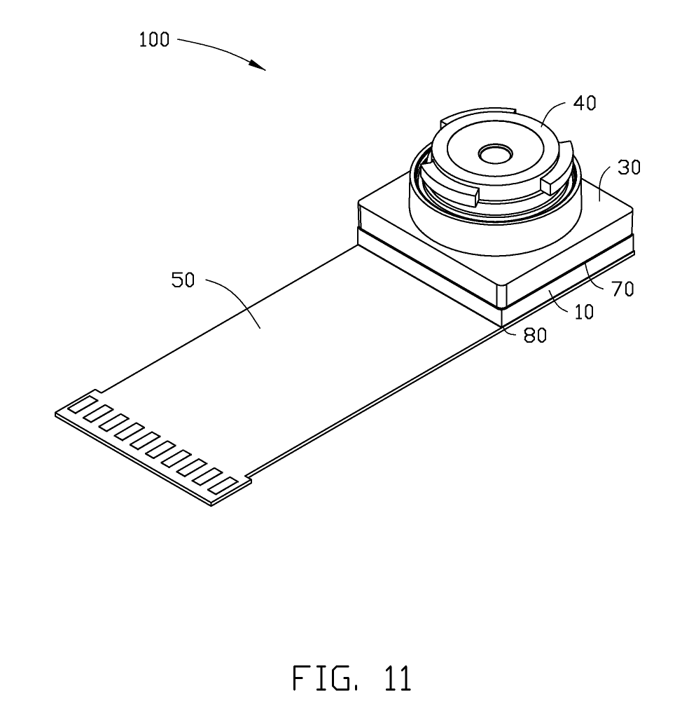

At block 010, referring also to FIG. 11, the substrate 10 is pressed on the position of the connecting board 50 with the ACF positioned thereon to make an electrical connection between the connecting board 50.

Because the first adhesive 60 is distributed to connect the side surfaces of the image sensor 20 and surface of the substrate 10, a connection strength between the image sensor 20 and the substrate 10 is enhanced, therefore, a warp of an edge of the image senor 10 relative to the substrate 10 in a pressing process can be avoided. Thus an assembling precision of the camera module is ensured.

It is believed that the present embodiments and their advantages will be understood from the foregoing description, and it will be apparent that various changes may be made thereto without departing from the scope of the disclosure or sacrificing all of its material advantages, the examples hereinbefore described merely being exemplary embodiments of the disclosure.

What is claimed is:

1. A camera module, comprising:
a substrate;
an image sensor electrically connected to a surface of the substrate, the image sensor comprising a sensing surface and a plurality of side surfaces connected to the sensing surface;
a lens holder connected to the substrate and configured to cover the image sensor;
a lens module received into the lens holder; and
an ACF positioned between the substrate and a connecting board and electrically and mechanically connecting with the substrate and the connecting board;
wherein an adhesive is distributed on each corner of the image sensor, and the adhesive connects the side surfaces of the image sensor to the substrate.

2. The camera module of claim 1, wherein the substrate comprises a supporting surface and a connecting surface apposite to the supporting surface, the image sensor is positioned on the supporting surface, and the connecting surface is connected to the connecting board.

3. The camera module of claim 2, wherein the substrate comprises a plurality of first connecting pads formed on the connecting surface, the connecting board comprises a plurality of second connecting pads corresponding to the first connecting pads, and the first connecting pads are electrically connected to the second connecting pads by the ACF, respectively.

4. The camera module of claim 1, wherein the substrate is a rigid PCB.

5. The camera module of claim 1, wherein the connecting board is a flexible PCB.

6. The camera module of claim 1, wherein the image sensor is selected from one of a group consisting a CCD and a CMOS sensor.

7. The camera module of claim 1, wherein the lens holder comprises a receiving end and an assembling end connected to the receiving end, the lens holder defines a receiving hole in the receiving end, the lens module is received into the receiving hole, and the assembling end is connected to the substrate.

8. The camera module of claim 7, wherein the assembling end is connected to the substrate by a second adhesive.

9. The camera module of claim 8, wherein the assembling end comprises a connecting surface facing away from the receiving end, the connecting surface is connected to the substrate surrounding the image sensor, and the second adhesive is distributed between the connecting surface and the substrate.

10. A method for assembling a camera module, comprising steps of:
providing a substrate and distributing a mounting adhesive on a predetermined position of a surface of the substrate;
providing an image sensor and mounting the image sensor on the predetermined position of the substrate;
solidifying the mounting adhesive to adhere the image sensor on the substrate;
electrically connecting the image sensor to the substrate;
providing a lens holder and a lens module and mounting the lens module into the lens holder;
distributing a first adhesive on each corner of the image sensor and distributing a second adhesive on the surface of the substrate surrounding the image sensor, the first adhesive being distributed on the surface of the substrate and the side surfaces of the image sensor;
mounting the lens holder on the substrate, and the second adhesive being sandwiched between the substrate and the lens holder;
solidifying the first adhesive and the second adhesive;
providing a connecting board and positioning an ACF on a surface of the connecting board;
pressing the substrate on the position of the connecting board with the ACF positioned thereon to make an electrical connection between the connecting board.

11. The method of claim 10, wherein the first adhesive and the second adhesive are thermosetting adhesive.

12. The method of claim 10, wherein the mounting adhesive is thermosetting adhesive.

13. The method of claim 10, wherein the image sensor is electrically connected to the substrate by a wire bonding process.
